(19) United States
(12) Patent Application Publication
(10) Pub. No.: US 2025/0054241 A1
(43) Pub. Date: Feb. 13, 2025

(54) A SYSTEM AND A METHOD FOR LIVE STREAMING BY USE OF AN AUGMENTED REALITY (AR) TECHNOLOGY

(71) Applicant: Philip STAIB, Soenderborg (DK)

(72) Inventor: Philip STAIB, Soenderborg (DK)

(21) Appl. No.: 17/431,443

(22) PCT Filed: Feb. 20, 2020
(86) PCT No.: PCT/DK2020/050046

§ 371 Date: Feb. 8, 2022

(30) Foreign Application Priority Data
Feb. 21, 2019 (DK) PA 2019 00228

(51) Int. Cl. G06T 19/00; G06V 20/20; H04N 21/2187; H04N 21/422; H04N 21/81; H04N 23/63

(52) U.S. Cl. CPC G06T 19/006; G06V 20/20; H04N 21/2187; H04N 21/42203; H04N 21/812; G06T 2200/24; H04N 23/631

(57) ABSTRACT

The present invention concerns an augmented reality (AR) system and a method for presenting real time live video streaming content within at least one defined AR border (301) consequent to detecting at least one AR tag (300). The present invention may comprise entity (500) location information of a video content capture device (502) for legitimation. The present invention may also provide common features and functions connected to the presentation of AR content such as accessing more information or ordering a related product. This invention is especially useful when promoting a product where transparency supporting authenticity plays a key role and, in any case, where it is necessary to limit where, when, and how users experience real time live video streaming content like in a sports bar. It is also useful when experiencing real time live video streaming content without depending on physically touching a device or using voice controls.

### TECHNICAL FIELD

The present invention relates to augmented reality technology, and more particularly to a method and a system for presenting real time live video streaming content.

### BACKGROUND ART

The present invention covered by this disclosure is based on augmented reality technology.

Augmented reality (AR) is known as presenting content as a digital layer, where digital content is augmenting the “real” or the non-digital world (that is, reality) by superimposing supplemental information (such as, pictures, videos, three-dimensional (3D) models, and other sensory enhancements) onto the real-world environment. The AR technology overlays virtual objects onto the image of the real world, enhancing a user's perception of reality and providing a user with an immersive, interactive experience and has been used for a long period to fulfil many purposes such as communication within advertisement, education, healthcare, maintenance and construction. As AR technology has advanced it has been further used to present real time live video streaming content also known as live broadcasting. (NPL1)

Real time live video streaming is used as the term for capturing, transmitting, receiving, and presenting what has been captured. The same event is also covered by the term: live broadcasting. Although both being the same in aspect of presenting video content directly, the term real time live video streaming is used in this disclosure as it distances itself from broadcasting because its functionality is often extended by common features such as pausing, allowing the viewer to go back on the timeline to watch something previously presented, or even interacting with the real time live video stream such as commonly seen on social media where the viewer for example can like, comment, or even save a picture of the content whilst the content provider is live streaming the video in real time. Augmented reality (AR) real time live video streaming refers to real time live video streaming executed as augmented reality. In this disclosure, for the sake of simplicity, real time live video streaming by an AR device is the event of AR real time live video streaming.

Live streaming in its general term is considered streaming data, whereas real time live video streaming is referred to in this disclosure as the event where the representation of captured video content is presented immediately by streaming video content data to a device operable for receiving and presenting this live content in real time. Likewise live broadcasting, there will always be a small delay from what is playing out in front of the video capture device and what is presented to the end viewer comparable to how there will always be a delay within human biology between what is playing out and what is perceived or comprehended. The reason being the time it takes before light photons have been received through the eyes, a signal send to the brain by nerves, and processed by the brain representing an illusion of the world based on photon data. Real time live video streaming means that the process of capturing, transmitting, receiving, and presenting video content happens consequently in real time. Yet, with a natural and less significant delay.

An example of AR real time live video streaming is Microsoft HoloLens with Skype. The hardware HoloLens from Microsoft is an AR headset also known as a head mounted AR device whilst Skype is the software program. Together as an AR device, it is operable for capturing video content, transmitting it while simultaneously receiving video content data and presenting it as augmented reality in real time. (NPL2)

Video live streaming is a well-known communication tool to assure users about real life conditions and has been widely used by for example TV stations to display events such as news, sporting events, or peculiar weathers online as well as in marketing when assuring potential customers.

An example of assuring potential customers is by providing the option of observing part of a production associated to a product in real time which has been done to the alcoholic liquor “Linie Aquavit” by LINIE who utilized live streaming to prove to some doubting people that the liquor “Linie Aquavit” is being sailed across the equator twice to mature. The real time live video stream covered its entire sea journey around the world around the clock 24/7 combined with location data of the ship which could be experienced through the webpage LINIE.com/live/to ensure legitimacy. (NPL3)

All in all, the medium augmented reality and real time live video streaming as a tool of communication has been and is used to fulfil many purposes. Yet, when not executed rightly as for example within marketing it can result in poor confidentiality. Branding can be beneficial to the consumer but also superficial and manipulating as pictures and videos can easily represent different conditions than the originals. Consumer reviews can be affected by other factors and therefore providing a misguided review of the product as much as certificates and quality stamps can be wrong due to other reasons whereas corruption is a known one within certain industries and countries. A brand's credibility can be achieved through honesty which translates into transparency.

Except for the example of LINIE, none of the abovementioned examples of marketing create transparency to an extend where the user can be assured of what is presented to them independent of a brand's goodwill or other parameters.

Augmented reality is a media like any other media carrying a message from a sender to a receiver. Nonetheless, AR stands out from other media by augmenting the non-digital world with digital content.

While it is well known presenting real time live video streaming as well as it is well known to augment a visual object with digital graphical content known as augmented reality, it is not taught in the background art to combine the use of detectable information, namely AR tags, with real time live video streaming to be presented within a defined AR border comprised by an AR tag.

Therefore, while each of the different apparatuses, systems, and methods disclosed in the above references as background art are suitable for the uses and problems they intend to solve, there is an ongoing need for improvements in augmented reality real time live video streaming. A system and a method that can provide more control to the content provider and thereby limit the user experience to prevent infringing permits, overloading users with information, and in some cases creating transparency.

### SUMMARY OF INVENTION

Accordingly, a primary object of the present invention is to provide an augmented reality (AR) system and method for presenting real time live video streaming content within at least one defined AR border activated by at least one AR tag, the system comprising;
at least one AR tag comprising at least one defined AR border;
an AR device operable for presenting real time live video streaming content within a defined AR border based on detection of at least one AR tag.

The system, wherein the function of presenting real time live video streaming content upon detecting at least one AR tag is regulated consequent to detecting at least one or a combination of several AR tags.

Alongside the system, an object of the present invention is to provide a method for presenting real time live video streaming content within at least one defined AR border activated by at least one AR tag the method comprising;
an AR device detecting at least one AR tag and upon detection of such presenting real time live video streaming content within at least one defined AR border comprised by at least one detected AR tag.

### Technical Problem

Experiments with augmented reality real time live video streaming has started recently as AR technology evolves. Still, the content providers do not have the complete ability to control when, where, and how AR real time live video streaming content is played out which can be a crucial element for their business and their communication strategy. For example, when it is important to present real time live video streaming content within a specific time, place, and or connected to certain elements for the sake of creating strong associations between real time digital content and a certain product.

Examples of these problems would be when real time live video streaming content is used to legitimate the overall or part of a production associated with a related product. For example, in order to assure a potential customer parts of the original condition of a production while creating strong associations between the real time live video streaming content and the product itself. For example, when presenting a real time live video streaming of milk producing cows on associated milk packaging. However, current solutions of displaying real time live video streaming content as a standard and by augmented reality do not offer a way to control the experience of real time live video streaming content to be limited to be presented exclusively associated to a certain product as well as time, or place.

Another example of a technical problem is in a sports bar where there is a limited amount of space for screens and projectors displaying sporting events. The sports bar sells beverages, snacks, and food in exchange for allowing guests to watch sporting events but in return the sports bar must secure permits to show the events. Which technical solution can offer a bar guest to see specific real time live video streaming content of a specific sporting event without occupying space while securing not infringing sporting event copyrights?

### Solution to Problem

The solution is real time live video streaming by use of an augmented reality technology allowing the content provider to control when, where, and how to present AR content by using augmented reality tags along with augmented reality borders (AR borders). An AR tag is combined with or directly connected to an AR border where the AR tag defines where and when content can be played out, whereas the AR border defines how by comprising a concrete frame as a limitation for content to be presented.

For example, a potential consumer in a convenience store can see a real time live video streaming of cows on the milk packaging but only on the actual milk packaging within a frame due to the limitations of the AR border framing a third of the packaging in the middle right below an upper text indicating the name of the product but above a lower label indicating the associated brand. The AR border defines exactly how the AR content is presented on the packaging by defining the space on the packaging where content can play out and the format. The real time live video streaming reflects good conditions of the cows which is thereby associated to the actual milk product and brand convincing the consumer to choose that product over similar products as these production conditions appeal to the user's morals and ethical convincement. The AR tag consisting of a graphical layout of the milk packaging comprises identification to the AR device and secures the necessity of the user to be in possessing of the actual milk packaging in order to experience the augmented reality live video streaming content. This benefits the seller as the potential customer must buy the milk product in order to experience the AR content at home.

Another example is in a sports bar where all screens are presenting sporting events. Some guests request to see a specific sporting event which is not displayed due to lack of space and screens. Through an AR device such as a smartphone or an AR headset the guests are able to enjoy the specific sporting event without the sports bar having to compromise one of the occupied screens. However, the AR tag and AR border secure that the real time live video streaming is only available and playable inside the sports bar as the AR tag and border are defined by actual location data of the bar. The AR tag is defined by coordinates of the Global Positioning System (GPS) location. The AR device detects the AR tag based on GPS data which makes real time live video streaming of the specific sporting event available to the user within that specific location in the sports bar. The AR border is comprised by the AR tag and is defining its frame by the same GPS data and the real time live video streaming is presented anywhere within the AR tag. Thereby, the real time live video streaming can be presented only within that frame specific to the local location of the sports bar. Once the guest moves outside the specific GPS-zone of the bar, the real time live video stream is no longer playable.

The AR tag in the bar could also be more specific to a graphical layout in the bar such as a poster of a beer product and to a specific time of the day. The AR tag thereby limits the experience of the sporting event to be presented associated to the poster during a specific time such as the happy hour of the bar.

The combination of AR tags and AR borders provides a technical solution to content providers to control where, when, and how augmented reality real time live video streaming is presented saving physical space and occupying screens.

### Advantageous Effects of Invention

Primary, the advantages effects of the invention are the possibility to control where, when, and how AR real time live video streaming content is played out. Where and when is controlled by the AR tag whilst how is depending on the defined AR border which is comprised by at least one AR tag.

By controlling where, when, and how presenting real time live video streaming content becomes an advantage when exclusivity is of a significant value. With AR tag, where and when provide the possibility to limit content to only be presented when certain requirements are fulfilled as the AR tag can be controlled. For example, if one content provider wants to limit the AR experience to a certain place and or a certain time. With a defined AR border the experience of how the real time live video streaming is presented is controlled which is an advantage when for example it brings a significant value to associate the real time live video streaming content with a product or service. For example, when presenting real time live video streaming of cows on a related milk product. The association of healthy organic free-range cows and a bottle of organic free-range milk is convincing by assuring the potential customer about good production conditions.

Moreover, an advantage of augmented reality real time live video streaming is the possibility to interact without depending on having to physically touch a button or screen by which the real time live video streaming is presented or by voice controlling the presentation device. For example, when the user wants to pause the real time live video stream on a milk packaging. AR is operable for interactivity by for instance the function of recognizing an object like a finger. By this means, activating the pause function by either physically pushing an augmented reality pause-button on the milk packaging with the recognized finger, holding the finger over the pause-button for a certain amount of time, or in another way indicate the wish of activating the pausing function saves the user for touching or giving a voice command to the AR device.

Another example when it is valuable not to be depending on touching a physical screen is when a user is wearing an AR headset while kneading a dough in a kitchen with sticky fingers and runs out of milk. Next to experiencing a real time live video streaming of cows on the milk packaging, AR is operable for common functions displayed as visual graphics as digital layers augmenting the milk packaging like the real time live video streaming. An example is a digital button or ikon for ordering more milk. It is an advantage to be able to interact with the real time live video streaming along with common features like reordering milk without having to touch a screen as the user thereby avoids staining the screen with the fingers.

Moreover, a further advantage of having functions within the real time live video streaming as augmented reality as well as functional ikons associated to the content is the forestall of having to create digital content in various formats for different displays.

It is to be understood that both the foregoing general description and the following detailed description are exemplary, and are intended to provide further explanation of the invention as claimed. Other advantages and features of the invention will be apparent from the following description, drawings, and claims.

### BRIEF DESCRIPTION OF DRAWINGS

The disclosure of invention set forth below, in connection with the accompanying drawings, is intended as a description of various embodiments and is not intended to represent the only embodiments in which the disclosure may be carried out or practiced. The disclosure includes specific details to provide a thorough understanding of the embodiments. Without regard to, it will be apparent to those skilled in the art that the disclosure without these specific details, in some instances, well-known structures and components are shown in simplified form for brevity of description.

The technical contents and detailed description of the present invention are described thereinafter according to a preferable embodiment, being not used to limit its executing scope. Any equivalent variation and modification made according to appended claims is all covered by the claims claimed by the present invention.

The functions and features of the invention believed to be novel are set forth with particularity in the appended claims. The invention itself, however, may be best understood by reference to the following detailed description of the invention, which describes exemplary embodiments of the invention, taken in conjunction with the accompanying drawings, in which:

FIG. 1 is a functional block diagram of a system, for creating the augmented reality experience in connection with a real time live video streaming according to an exemplary embodiment of the invention.

FIG. 2 is a graphical representation of an embodiment of AR real time live video streaming provided by the system of FIG. 1; where a finger is interactive with the AR content.

FIG. 3 depicts one embodiment of a system for creating the augmented reality experience in connection with a real time live video streaming related to FIG. 1 according to a shopping experience focusing on coconuts in a grocery store.

FIG. 4 depicts one embodiment of a system for creating the augmented reality experience in connection with a real time live video streaming related to FIG. 1 according to an event focusing on an experiencing a sporting event in a sports bar.

FIG. 5 is a flowchart of operating an AR user device related to FIG. 1 when AR real time live video streaming by the system of FIG. 1 is running.

FIG. 6 is a flowchart of operating an AR user device related to FIG. 1 when AR real time live video streaming by the system of FIG. 1 is running and processing happens externally.

FIG. 7 is an example of a graphical representation of the display of an AR device when AR real time live video streaming by the system of FIG. 1 is running.

FIG. 8 is an example of a display flow chart of an AR device when AR real time live video streaming by the system of FIG. 1 is running.

FIG. 9 is a block diagram illustrating an example of the Augmented Reality Software Module (404) that may be used in connection with various embodiments described herein.

FIG. 10 is a block diagram illustrating an example of the Computing Module (503) that may be used in connection with various embodiments described herein.

### DESCRIPTION OF EMBODIMENTS

In cooperation with attached drawings, the technical contents and detailed description of the present invention: A system and a method for live streaming by use of an augmented reality (AR) technology, are described thereinafter according to a preferable embodiment, being not used to limit its executing scope. Any equivalent variation and modification made according to appended claims is all covered by the claims claimed by the present invention.

Reference will now be made to the drawing figures to describe the present invention in detail.

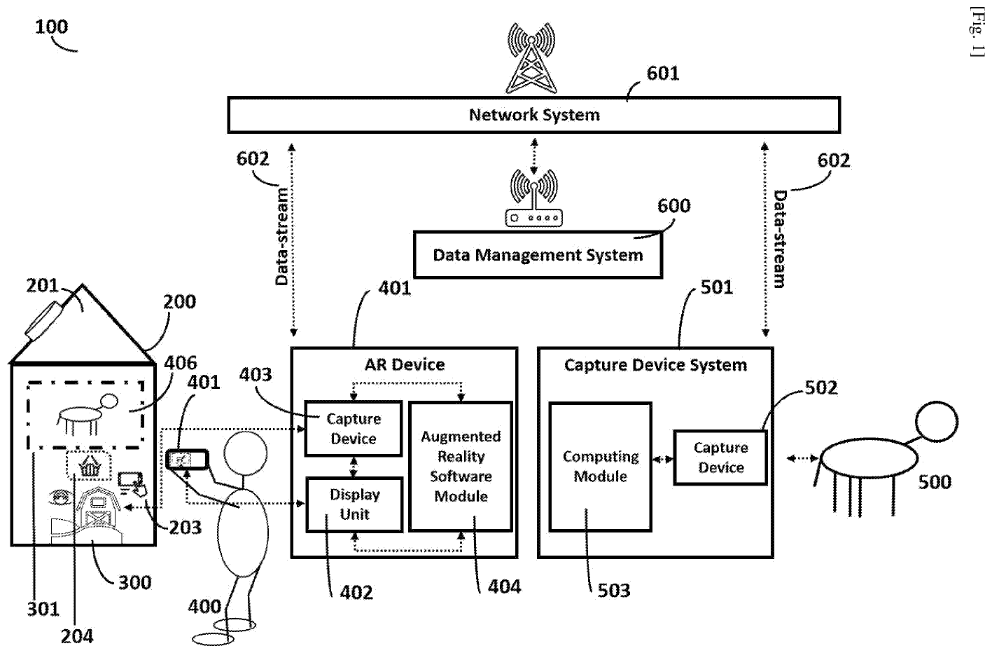

Reference is made to FIG. 1 which is a functional block diagram of a system, for creating an augmented reality experience in connection with real time live video streaming content according to the exemplary embodiment of the invention. The augmented reality real time live video streaming system denoted at 100.

The present invention has particular utility in connection with a real time live video streaming on a product such as one of organic free-range cows on a milk packaging. Nevertheless, it is to be understood that the present invention can similarly be used in any number of augmented reality experiences such as watching a live sporting event or the like. For purposes of simplicity, reference will be made to the real time live video streaming of a bunch of cows. Specifically, a bunch of organic free-range cows representing the cows producing the milk of a milk product, alternatively an example of the invention used on coconuts in a grocery store and another example of the invention used with a sporting event in a sports bar, will follow throughout the ensuing description and following examples.

The augmented reality real time live video streaming system (100) enables detecting at least one augmented reality tag (300) with an AR border (301).

The system (100), generally comprises: (a) at least one AR tag (300) with at least one defined AR border (301); (b) an AR user device (401); (c) a Capture Device System (501); (d) a Data Management System (600) the Data Management System (600) being connected (602) to the AR user device (401) and the capture device (501) by a Network System (601).

Although controlling two different functions the function of AR tag (300) and the function of AR border (301) may be based on the same detectable information or may be based on different information.

The AR tag (300) also known as a marker may be any identifiable information such as a visual graphic, sound, light, temperature and other detectable physical properties as well as Global Positioning System (GPS) data and the like. A visual graphic may be a visual graphic such as an image, Quick Response (QR) code, the certain shape of an object, or a colour code. Sounds may be a certain sound frequency or a certain combination of frequencies being a sound code. Light may be a certain colour or frequency or a certain combination of frequencies being a light code. Global Positioning System data is the actual position or the position including a certain radius. The function of the AR tag (300) is to be detected by the AR user device (401) and by being so providing access for the AR user device (401) to present AR real time live video streaming content. The function of presenting real time live video streaming content upon detecting at least one AR tag (300) is regulated consequent to detecting at least one or a combination of numerous AR tags (300). Detecting a combination may be executed by detecting numerous AR tags consequent to each other, simultaneously, randomly, or the like. For example, detecting one AR tag being a visual graphic such as an image may fulfill the requirement to allow real time live video streaming content to be presented. Another example is the requirement of detecting an AR tag being a visual graphic as well as an AR tag in the form of a sound code simultaneously in order to fulfill the requirement to present real time live video streaming content.

The AR border (301) is a function technically defining how AR content can be presented. The AR border (301) is defining a frame in the non-digital environment also called the “real world” where AR real time live video streaming content can be presented. An AR border (301) definition of a frame may be the size and the position of the frame relative to the AR tag (300) or it may be within a limited area which can be limited by the same identifiable information that defines the AR tag (300). By way of example, the AR tag (300) may include a requirement of for example a certain combination of AR tags (300) in order to initiate the process of presenting AR real time live video streaming content within a defined frame of the AR border (301). The AR border (301) consists of software codes and its function can be achieved by many means of coding which is well-known to those skilled in the art. The function of detecting an AR tag (300) as well as the requirements of fulfilling a combination of AR tags (300) to present content also consist of software codes and the functions can be achieved by many means of coding which is well-known to those skilled in the art.

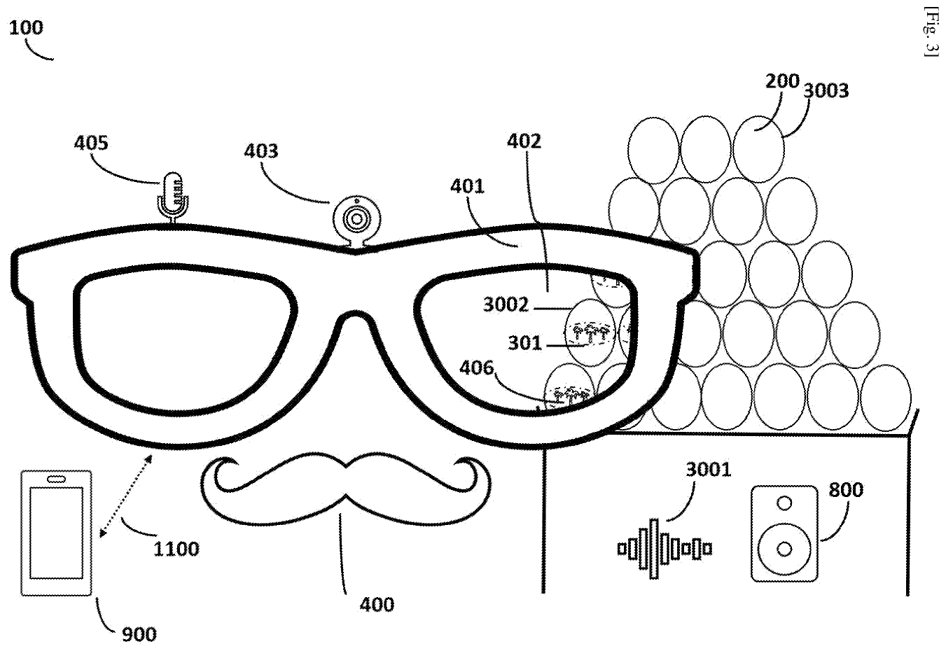

The AR user device (401) referred to as the AR device (401) may be a smart phone, tablet computer, AR headset, digital glasses, retinal projection glasses with holographic display or the like and possible for the future being digital contact lenses and neurone-devices reacting and interacting on neurons activity in the brain. The AR device (401) includes a capture device (403) such as a camera configured to capture a video signal or the like which can include a microphone (405, FIG. 3) configured to capture a sound signal. The AR device (401) further includes a display unit (402) for presenting or representing AR content. The display unit (402) may be a screen for the visual presentation of AR content such as a smartphone screen or display, a laser for retinal projection, a projector or the like. The AR user device (401) may further include a computer processing unit referred to in this disclosure as an Augmented Reality Software Module (ARSM) (404). The ARSM (404) is operable for the ability to perform well-known, for those who are skilled in the art, AR protocols which includes recognizing an AR tag (300), send a request for AR content or generate AR content, receive and process AR content, present or represent AR content according to an AR border (300). The ARSM (404) may also be operable for recognizing objects such as a finger or the like for processing interaction with AR content such as activating a feature like pausing a playing video stream by performing an act with the finger relative to the AR content. In this regard, it is noted that there already exist many different ways to identify or detect AR tags (300) and present AR content that are already well known and employed in video capture, virtual reality, and augmented reality systems. Accordingly, detailed description of such methods for identify or detect AR tags (300) and present AR content is omitted from the description. However, purely by way of example, processing and generating data that may be employed for presenting AR content include contrast detection algorithms, face recognition algorithms, entity recognition algorithms, 3D spatial tracking algorithms and the like. It is important to note that when detecting and AR tag (300) and by this mean present AR content does not require that the AR tag (300) and where the AR content is presented within a defined AR border (301) must be captured simultaneously by a capture device (403). The AR tag (300) may comprise data or access to data making it possible for the AR device (401) to orient itself relative to the AR tag (300). For example, an AR tag (300) being a logo on a milk packaging (201) may present on the front side of the packaging (201) right above the AR tag (300) a real time live video stream of cows. However, on the backside of the packaging (201) where the AR tag (300) is not visible, the AR device is still capable from previous detection of the AR tag (300) of presenting content such as a real time live video streaming of the milk assembling line associated with the milk. This works by launching what by this disclosure is referred to as a secondary AR tag. By detecting the logo of the milk packaging as the primary AR tag (300), the shape of the milk packaging becomes the secondary AR tag so that when the user (400) turns the packaging the AR device is operable for processing the whole shape of the packaging as connected to the primary AR tag (300) and thereby presenting real time live video streaming content independent of continuously capturing the primary AR tag (300).

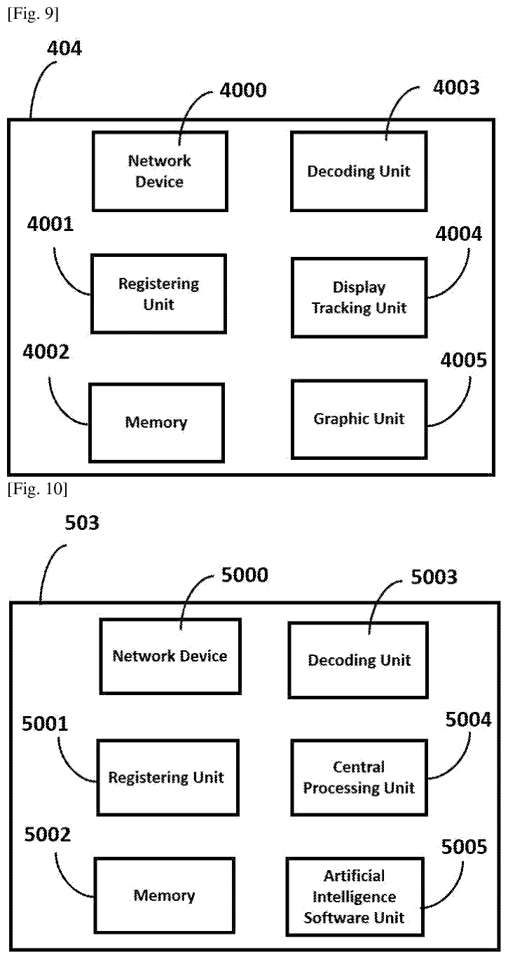

In general, an ARSM (404, FIG. 9) may comprise a network device (4000), a registering unit (4001), a memory (4002), a decoding unit (4003), a display tracking unit (4004), a graphic unit (4005). Note that, in the present and following specification and the like, the term “unit” does not only simply mean a physical configuration but also includes a case in which the function of the configuration is realized by software. The network device (4000) is operable for connecting to networks while the registering unit (4001) is operable at registering received data. The memory (4002) is operable for storing data while the decoding unit (4003) is operable for decoding received data or compress data. The display tracking unit (4004) is operable for tracking entity information such as a milk packaging (201) provided by the data from the capture device (403) and present digital content accordingly as defined by at least one AR border (301). The display tracking unit (4004) maintains the position of the displayed AR image in relation to at least one AR defined border as the border moves within the field of view of the capture device (403). The graphic unit (4005) is operable for generating related digital graphic.

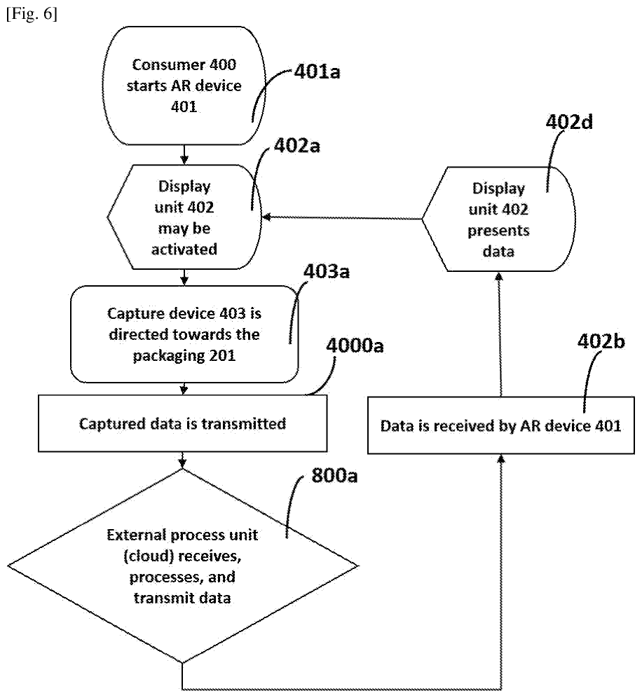

The function of the ARSM (404) may also happen in a cloud well-known as the phenomenon cloud computing being one or several connected computer modules operable for receiving, processing, and transmitting data. Thereby, the AR device (401) may just be a device operable for capturing information, transmitting, receiving, and presenting data by the use of a capture device (403), a display unit (402), and a Network System (601). The full processing or part of the processing of data by the ARSM (404) may instead be processed externally online in a cloud or in another device connected to the AR device (401). For example, the AR device (401) may be a pair of AR glasses that only captures and presents AR content while sending all captured data by for example Bluetooth (1100) to a smartphone (900, FIG. 3) which is the processing unit of this data or the smartphone (900) further directs the data to be processed externally in a cloud (800a, FIG. 6). However, the AR device (401) may be operable of executing all functions of capturing data, processing data, requesting data, receiving data, processing received data, and presenting data.

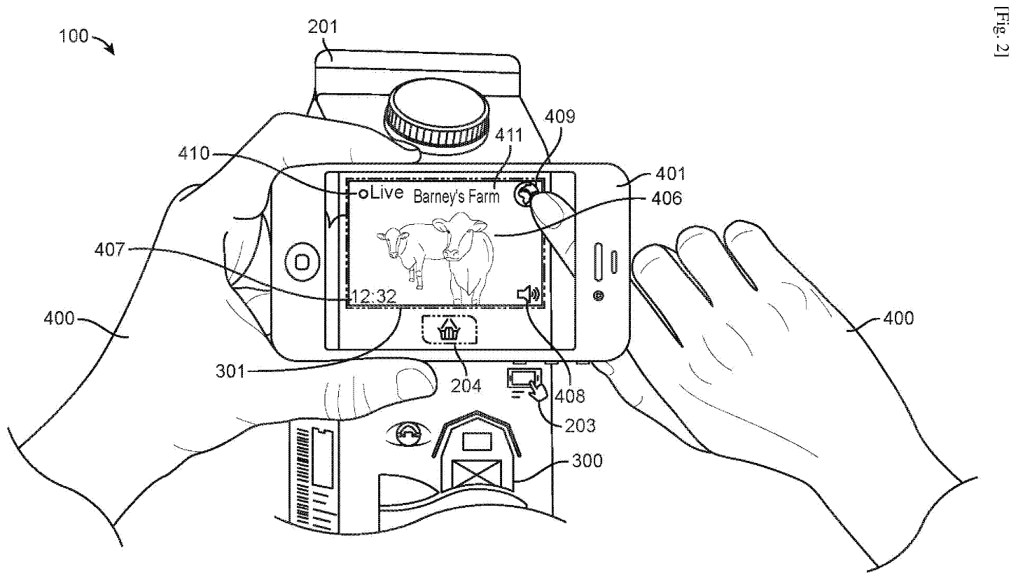

FIG. 2 demonstrates an example of such procedure where a consumer (400) starts (401a, FIG. 6) an AR device (401). There might be a display or not as part of the AR device (401) depending on the AR device (401). For example, being a smartphone, it has a display but being a pair of AR glasses or wearables with retinal projection it might not comprise a display. For the sake of exemplary the AR device (401) is a smartphone with a display that is activated (402a). The capture device (403, FIG. 1) of the AR device (401) being the smartphone camera is directed towards a milk packaging (201), (403a). Instead of processing all captured data the data is transmitted (4000a) to an external process unit being a cloud (800a). Once the cloud has processed the data it sends back relevant data to the AR device (401), (402b). The data comprise information weather to present real time live video streaming content or not. If at least one AR tag (300) comprising and AR border (301) is detected comprising information about presenting real time live video streaming content, then the data is presented on the display of the smartphone (402d) according to processed AR tag (300) and AR border (301) information (403a).

The AR device (401, FIG. 1) and the Capture Device System (501) include means for indirectly (through another device) or directly accessing an internet server. Means for accessing internet servers are well-known to those skilled in the art and include broadband, cellular data, Wi-Fi, and other wireless access technologies, and as such shall not be discussed in detail hereinbelow.

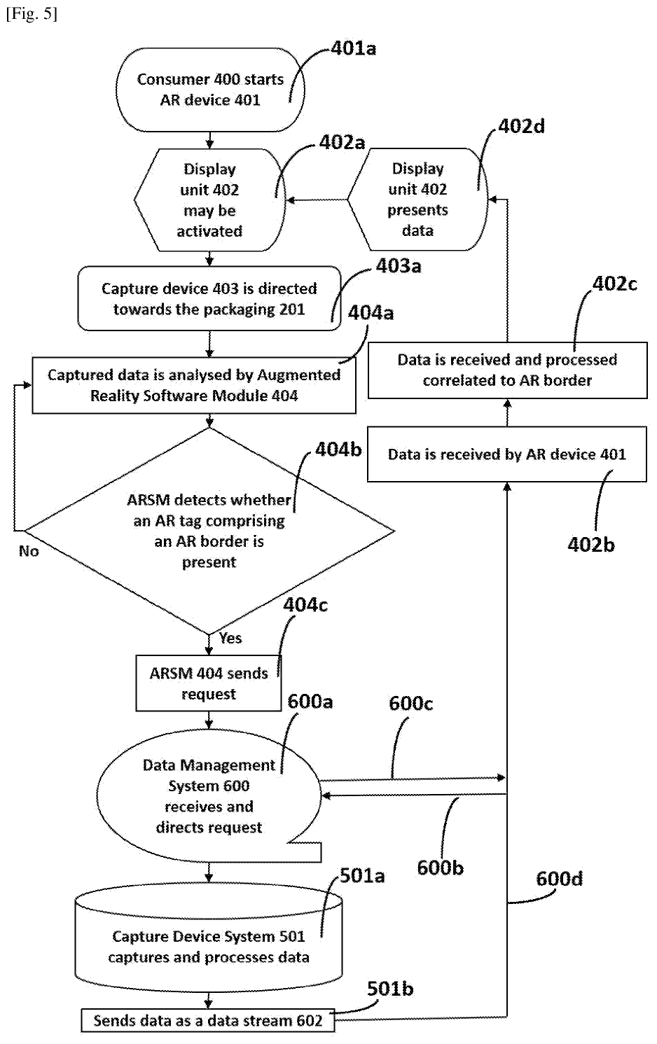

The Capture Device System (501) is operable for capturing content and transmitting it to the AR user device (401) through a Data Management System (600) or it may directly transmit data (600d, FIG. 5) to the AR user device (401) by means for accessing a Network System (601) or the like. The Capture Device System (501) generally includes at least one capture device (502), a computing module (503), and may include a display for displaying video content or a setting panel for common adjustments. With numerous capture devices (502) such as three cameras covering an entity like a cow (500) from different angles the real time live video streaming content can be presented in 3-dimensions (3D) such as atop a milk packaging (201) allowing the user (400) to turn around the milk packaging (201) or walk around it and experience watching the represented cow (406) from all sides and angles being augmented reality 3-dimensional real time live video streaming content (406). The capture device or devices (502) may be a camera and can further comprise one or several other content capturing technologies or formats such as night vision, infrared camera, and or virtual reality camera operable for capturing content in 360 degrees or the like which may include a microphone (405, FIG. 3) configured for capturing a sound signal. The computing module (503) is operable for processing video and or sound data and transmitting it. Furthermore, it may include artificial intelligence (5005, FIG. 10) for analysing video or sound data for executing the function of censoring at least parts of elements of video or sound data as used for example when an object in the video environment like a person is detected. It determines if the identified entity, also known as an object or element, is to be censored based on predefined protocols. Based on the identified entity being determined to be censored, the video recording is modified to replace at least a portion of the identified entity with a graphical element adapted to obscure the portion of the identified entity in the video stream. By modifying a video stream to obscure an entity, protected content in the environment or any other content that for legal or ethical reasons must not be represented may be prevented from being represented to a user of the AR user device (401). The function of the computing module (503) may also happen in a cloud well-known as the phenomenon cloud computing being one or several connected computer modules operable for receiving, processing, and transmitting data. In general, a computing module (503, FIG. 10) may comprise a network device (5000), a registering unit (5001), a memory (5002), a decoding unit (5003), a central processing unit (5004), an artificial intelligence software unit (5005). The network device (5000) is operable for connecting to networks while the registering unit (5001) is operable at registering received data. The memory (5002) is operable for storing data while the decoding unit (5003) is operable for decoding received data or compress data. The central processing unit (5004) is operable for processing data along with the artificial intelligence software unit (5005) which is operable for processing related artificial intelligence algorithms.

The Data Management System (600, FIG. 1) is operable for connecting the AR user device (401) with the Capture Device System (501) through means of accessing an internet server by a Network System (601). The Data Management System (600) directs data (602) between the Capture Device System (501) and the AR device (401).

The Network System (601) are well-known to those skilled in the art and include broadband, fiber-optic, cellular data, Wi-Fi, and other wireless access technologies, and as such shall not be discussed in detail hereinbelow.

### EXAMPLES

Reference is made to FIG. 1 and FIG. 5.

### Example 1: Making a Purchase Decision in a Convenience Store

A user (400) walks into a convenience store to buy milk. Several milk products are available side by side on the shelf. The milk product (200) is contained within a packaging (201). The milk packaging (201) comprises an AR tag (300) being a visual graphic of a label of the milk producer. Furthermore, the AR tag (300) comprises an AR border (301). The AR border (301) is defining a frame in the format of 16:9 with the measurements of 6 cm×3.38 cm positioned right above the AR tag (300). The user (400) recognizes an ikon (203) indicating that this milk packaging (201) comprises an AR feature. The user (400) takes an AR user device (401) (referred to as an AR device) being a smartphone and opens an app, webpage or the like wherein the AR function is installed or available (401a) and the screen or display (402) of the smartphone (401) presents what the capture device (403) being a smartphone camera captures (402a). The user (400) points the camera (403) towards the milk packaging (201), (403a). The AR user device comprising an Augmented Reality Software Module (ARSM) (404) analyses captured data (404a) and detects the AR tag (300), processes the identified information (404b), and sends a request for real time live video content (404c) through a Network System (601) to a Data Management System (600), (600a). The Data Management System (600) receives the request (600a) and directs data (602) from the Capture Device System (501) to the AR user (401), (600c). The Capture Device System (501) captures and processes data simultaneously (501a) as data is transmitted (501b). The AR device (401) receives the data (402b) and processes it correlated to pre-sets of the AR tag (300) and the AR border (301), (402c) and presents the real time live video streaming content (406),(402d). However, instead of The Capture Device System (501) directly sends data stream (602) to the Data Management System (600), (600b) the Capture Device System (501) may instead send the data stream (602) directly to the AR device (401), (600d). The user (400) sees the real time live video streaming content on the AR device (401) appearing as a visual overlay atop the milk packaging (201). The consumer (400) likes the experience of seeing the healthy cows and makes a purchase decision and buys the associated milk product (200).

Appearing above and in relation to the real time live video streaming content atop of the packaging (201) is an ikon (204) or the like operable for carrying out common functions such as ordering the milk. Instead of bringing the milk product (200) home the user (400) pushes the ikon or in any other way activates the ikon (204). Upon activation of the ikon (204) a function is executed. The function may be adding the milk product (200) to an online shopping list for home delivery or the like. FIG. 2 is a drawing demonstrating how the user (400) experiences the real time live video streaming content appearing on the display screen (402, FIG. 1) of the AR device (401) as a visual digital overlay (406) atop the milk packaging (201) as if existing as part of the milk packaging (201) itself.

Furthermore, the user (400) decides to go and see the represented cows (500, FIG. 1). By pushing the ikon or in any other way activating the ikon (409, FIG. 2) directions to the location of the Capture Device (502) are presented.

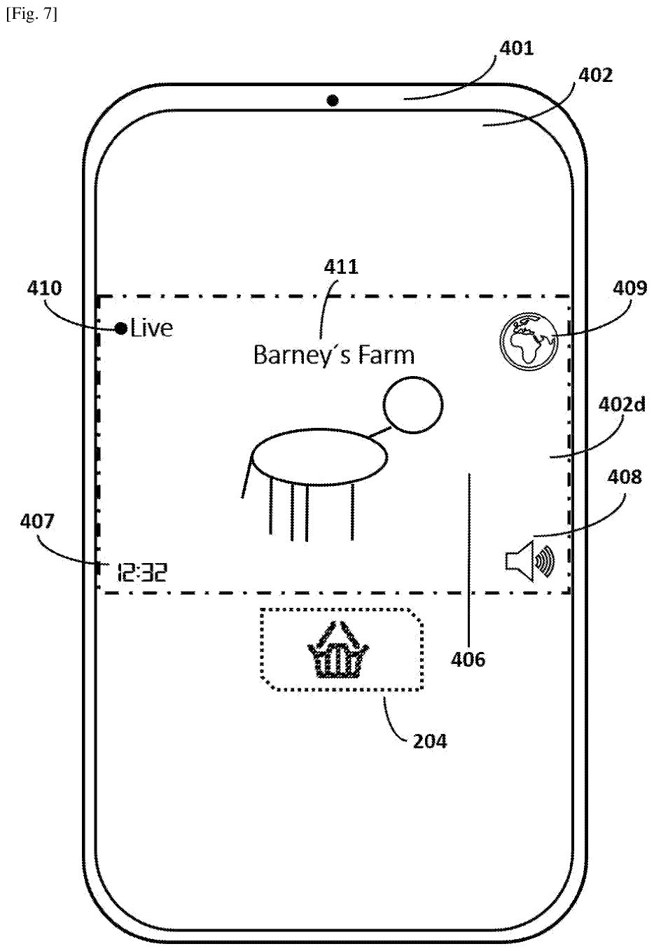

FIG. 7 is an example of the digital layout that is presented on top of the packaging (201) of the milk product (200) as seen through the AR device (401) in this case being a smartphone. An ikon indicates that the content is real time live video streaming (410). The numbers (407) indicates the local time of the capture device (502). The title (411) is the name of the production. The ikon (408) is indicating that sound is on. The ikon (409) is a function that can be activated to receive directions or the position of the capture device 502 or the production. The content (406) is the representation of the captured production (500).

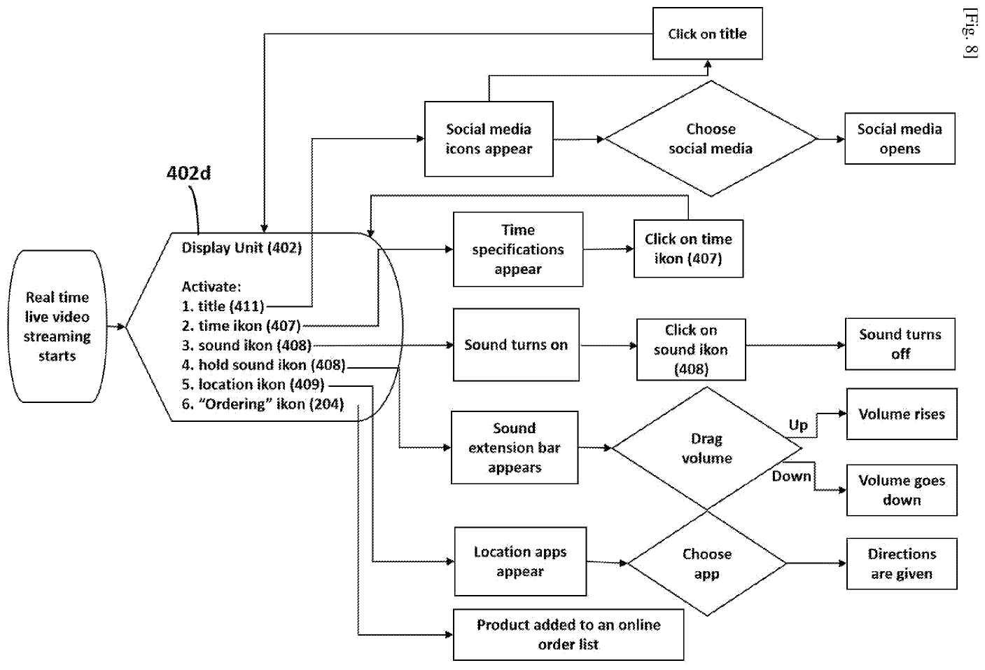

FIG. 8 is a display flow chart of an AR device (401) when AR real time live video streaming by the system of FIG. 1 is running. By activating the different ikons adjustments or further information become available.

Reference is made to FIG. 3.

### Example 2: Advertising a Coconut without a Packaging in a Grocery Store

A user (400) walks around in a grocery store wearing an AR user device (401) being a pair of AR glasses. The user walks into the fruits and nuts area whereas a bunch of coconuts are displayed. The coconuts (200) do not have packaging. Under the coconuts is a speaker (800) playing a sound code being an AR tag (3001) with frequencies between 21-23 kHz. The user (400) is not capable of hearing those high frequencies. Yet, the AR user device (401) is capable of capturing the sound code (3001) through its capture device by a microphone (405) and detects the sound code (3001). The AR user device (401) further detects an AR tag being the shape of a coconut (3002) and an AR tag being the colour code of a coconut (3003) through a camera (403). The combination of the three AR tags being the sound code (3001), the shape of a coconut (3002), and the colour code of a coconut (3003) are the three AR tags which regulate if real time live video streaming content can be presented as this depends on the AR device (401) detecting all the AR tags consequent to each other. The AR tags being detected consequent to each other meets the requirement to allow access to receive real time live video streaming content.

The AR tag (3002) based on the shape of the coconut comprises an AR border (301). The AR border (301) is defining a frame with an oval shape positioned in the middle of the coconut (200) filling up 35% of the coconut shell (200). Upon detection of the AR tags (3001), (3002), and (3003) the AR device (401) transmits by Bluetooth information to a smartphone (900) operable for processing data by an ARSM (404, FIG. 1) which executes its protocols as explained in previous example 1, resulting in presenting the real time live video streaming content of a coconut palm plantage related to the coconut.

The user (400) experiences real time live video streaming content of the coconut palm plantage and may swipe on the coconut, the content (406), to see real time live video streaming content from other capture devices (502, FIG. 1) representing the production (500) from other perspectives such as the food processing assembling line or the packaging division. When the user (400) moves out of the fruits and nuts area of the grocery store so that the sound code (3001) is no longer detectable by the AR device (401), the real time live video streaming content (406) can no longer be presented on coconuts. Thereby, the user experience of the real time live video streaming content of a coconut palm plantage (406) is only presented at the coconut section of the grocery store securing that the user is not disturbed by this promotional content in any other context when dealing with a coconut or a presentation of a coconut.

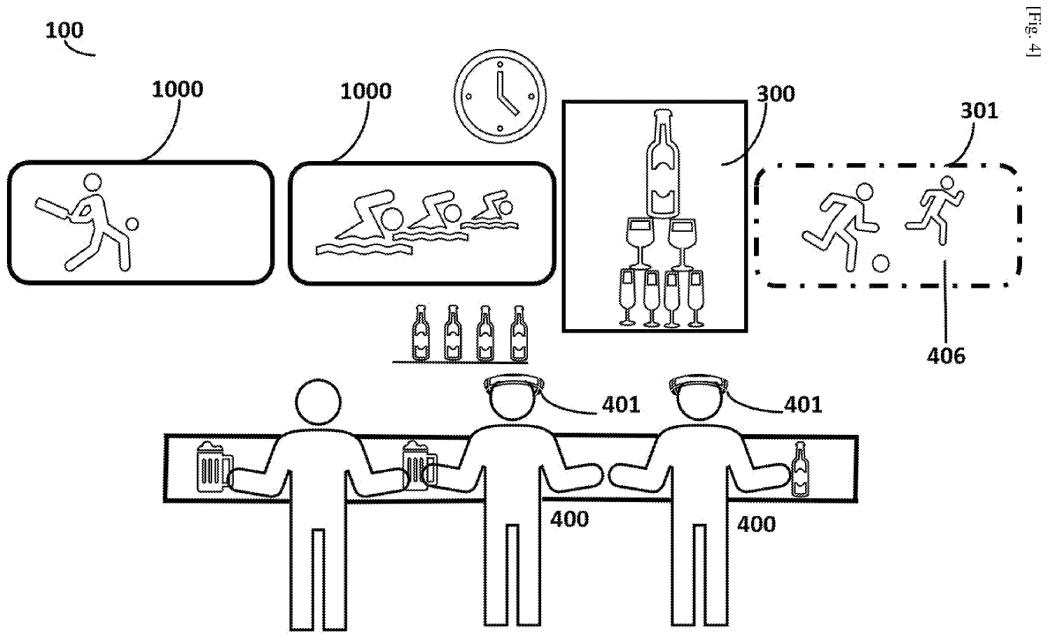

Reference is made to FIG. 4.

### Example 3: Sports Bar

Two users (400) located in a sports bar wish to see a certain sporting event which is real time live video streamed on a certain channel between 4 μm and 6 pm. Due to lack of screens (1000) the sports bar offers access to the sporting event by augmented reality. The users (400) receive AR user devices (401) being AR head-mounted displays. The AR tags (300) are based on the GPS data of the location of the sports bar, the time 4 μm and 6 μm, and the visual graphic (300) of a beer advertising poster hanging on a wall behind a bar. The AR border (301) is also based on the visual graphic of the beer advertising poster (300) defining a frame (301) in the format of 16:9 with the measurements of 150 cm×84 cm positioned right next to the right side of the beer advertising poster. At 4 pm the users (400) experience watching the real time live video streaming content (406) of the sporting event presented atop of the wall next to the poster (300) through the AR devices (401) until 6 pm. It is not possible for a user to bring the visual graphic of a beer advertising poster (300) home to experience the sporting event (406) at home between 4 pm and 6 pm as one of the three AR tags being the GPS data related to the location of the sports bar will be missing once the user is outside the sports bar. Thereby, the experience of the real time live video streaming content is limited securing that the sports bar is not infringing permits as well as keeping the two bar quests in the bar to improve their bar experience and thereby provide increased revenue opportunities for the sports bar.

The above description of the disclosed embodiments including the examples is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

### INDUSTRIAL APPLICABILITY

The invention covered in this disclosure is applicable in any industry where real time live video streaming content playing out through the augmented reality media is relevant. As such, the applicability has no certain limits. Yet, the primary intention of this invention is to provide a system and a method for content providers of real time live video streaming content to control where, when, and how AR live streaming content is played out as this can be a crucial element for their business and their communication strategy. The retail and entertainment industry are the two industries to which the objectives of this invention regard. However, the industrial applicability of this invention is not limited to only these two industries as the function of the invention may be applicable in many more industries.

### Non Patent Literature

NPL 1: “World's First Augmented Reality Educational Live Broadcast: Visiting Professor”, 28. Jun. 2018. Retrieved from: https://www.youtube.com/watch?v=1pJMSfZdTVw (seen 30.12.2019):
NPL 2: “Microsoft HoloLens: Skype”, 2016. Retrieved from: https://www.youtube.com/watch?v=4QiGYtd3qNI (seen 30.12.2019)
NPL 3: Linie Aquavit, 2018. Retrieved from https://linie.com/live/(seen 30.12.2019)

1. An augmented reality (AR) system for presenting real time live video streaming content within at least one defined AR border activated by at least one AR tag, the system comprising;
at least one AR tag (300) comprising at least one defined AR border (301);
an AR device (401) operable for presenting real time live video streaming content (406) based on detection of at least one AR tag (300).

2. The system according to claim 1, wherein the function of presenting real time live video streaming content (406) upon detecting at least one AR tag (300) is regulated consequent to detecting at least one or a combination of numerous AR tags (300).

3. The system according to claim 1 or 2, wherein the AR device (401) is a device operable for capturing data (403a), analysing captured data (404a), detecting at least one AR tag (300), (404b), requesting data (602), (404c) upon detection of at least one AR tag (300), receiving data (602), (402b), processing received data (402c), and presenting data in the form of real time live video streaming content (406), (402d) or the AR device (401) is a device operable for capturing data (403a), transmitting data (4000a), receiving data (402b), and presenting data in the form of real time live video streaming content (402d) whereas the processing of data happens partly or fully externally depending on other systems (800a).

4. The system according to any of the proceeding claims, wherein presenting real time live video streaming content (406) further comprising entity location information associated with a location of the source of the real time live video streaming content (406) as a feature directing the user (400) to the location of the capture device (502) or the location of captured content (500).

5. The system according to any of the proceeding claims, further comprising a function operable for censoring the presence of at least part of an entity in the environment (500) represented by the real time live video streaming content (406).

6. The system according to any of the proceeding claims, further comprising features common to a non-augmented reality experience of real time live video streaming content on a computer device such as the feature operable for letting the user select to have previous content apart from real time presented, accessing more information, commenting, liking, selecting an object to be liked, adding a filter, taking a snapshot also known as a screen shot, selecting ordering a related product (200), or any other common features contemplated by one of ordinary skill in the art.

7. The system according to any of the proceeding claims, wherein at least one capture device (502) operable for capturing content includes at least one microphone (405) operable for capturing sound.

8. The system according to any of the proceeding claims, wherein at least one capture device (502) operable for capturing content further comprises at least one additional content capturing technology or format such as night vision, infrared camera, or virtual reality camera operable for capturing content in 360 degrees, additional formats or sensors for detecting other physical properties.

9. A method for presenting real time live video streaming content within at least one defined AR border activated by at least one AR tag the method comprising;
an AR device (401) detecting at least one AR tag (300) and upon detection presents real time live video streaming content (406) within at least one defined AR border (301) comprised by at least one AR tag (300).
